(19) United States
(12) Patent Application Publication
(10) Pub. No.: US 2016/0306622 A1
(43) Pub. Date: Oct. 20, 2016

(54) METHOD OF UPDATING FIRMWARE USING SINGLE OPTICAL PORT COMMUNICATION AND MICROCONTROLLER CAPABLE OF UPDATING FIRMWARE

(71) Applicant: ABOV SEMICONDUCTOR CO., LTD., Cheongwon-Gun (KR)

(72) Inventor: Kyu Tae Kim, Cheongju (KR)

(21) Appl. No.: 15/192,484

(22) Filed: Jun. 24, 2016

Related U.S. Application Data
(63) Continuation of application No. PCT/KR2014/012622, filed on Dec. 23, 2014.

(30) Foreign Application Priority Data
Dec. 30, 2013 (KR) 10-2013-0167326

(51) Int. Cl. G06F 9/445; H04B 10/80

(52) U.S. Cl. CPC G06F 8/65; H04B 10/801

(57) ABSTRACT

A method of updating firmware using single optical port communication and a microcontroller (MCU) capable of updating firmware using single optical port communication are disclosed herein. The method includes detecting the voltage of a battery when a firmware update start code is received by a single optical port, transmitting firmware-related information to the transmitter if the detected voltage of the battery is equal to or higher than a predetermined reference voltage, receiving update data corresponding to an update mode, and storing rollback information related to previous version of firmware and also performing an update to new version of firmware in a first mode, and updating the predetermined data of the previous version of firmware using the update data in a second mode.

### CROSS-REFERENCE TO RELATED APPLICATION

This application is a continuation of PCT/KR2014/012622 filed on Dec. 23, 2014, which claims priority to Korean Application No. 10-2013-0167326 filed on Dec. 30, 2013, which applications are incorporated herein by reference.

### TECHNICAL FIELD

The present invention relates to firmware updating and, more particularly, to a method of updating firmware using single optical port communication, which can easily update the firmware of a microcontroller (MCU) via photo-electromotive force, generated in a light-emitting diode (LED) by a transmission function, by means of light radiated by a transmitter using single optical port communication, and a microcontroller capable of updating firmware.

### BACKGROUND ART

In general, today, various wireless communication methods are being used to control many electronic appliances and apparatuses provided in homes, offices, factories, etc. Various microcontrollers (MCUs) are being used to effectively control the appliances and apparatuses.

To update the firmware of an MCU, it is necessary to download new version of firmware used for updating via one of the various types of communication and replace the read-only memory (ROM) code of the MCU.

In the case of conventional radio frequency (RF) communication, permission must be obtained due to the scarcity of frequency resources. In contrast, optical communication can be substantially immediately used without the obtainment of permission for the use of frequency resources or interference with other uses.

Furthermore, optical communication uses light as a communication medium. Accordingly, the optical communication is harmless to humans because secondary electromagnetic waves are not generated, can be used in an airplane, a hospital, etc. where a serious problem may occur due to an erroneous operation or a malfunction, can easily minimize the interference of an optical input signal with other signals, and can be used for the combined use of communication and lighting when a visible light-emitting element, such as an LED, is employed.

Korean Patent No. 10-05524164 discloses a conventional method of upgrading a remote controller using optical communication. An apparatus for upgrading a remote controller includes a service provider configured to provide remote controller upgrade information; a user terminal configured to connect to the service provider over a predetermined network, request remote controller upgrade information, to display the requested remote controller upgrade information on a display device in the form of a brightness control block, and to provide the requested remote controller upgrade information; and a remote controller configured to detect the brightness control block displayed on the display device, and to receive the remote controller upgrade information. Accordingly, at least two optical sensors are contained in the remote controller, and remote controller upgrade information to be newly used can be easily received from the display device connected to the Internet.

However, in the conventional communication method using optical communication, a light emission unit (a transmission circuit) configured to transmit a signal and a reception circuit must be independently provided. Since the transmission circuit and the receiver circuit must be separately configured, an optical transmission element and an optical input detection sensor or optical input detection element (for example, a photodiode, a port transistor, a cadmium sulfide (CDS) sensor, or the like) are required. As a result, a set manufacturing cost is increased because the number of components required for the implementation of a corresponding circuit is large and also the implementation is complicated, and a chip manufacturing cost is also increased because the number of ports required for the implementation of a corresponding operation is at least two.

Therefore, there is a need for a technology that does not require the separate configurations of a transmission circuit and a receiver circuit and that can update the firmware of an MCU using a single port.

### SUMMARY OF THE DISCLOSURE

Accordingly, the present invention has been made to solve the above problems occurring in the prior art, and an object of the present invention is to provide a method of updating firmware using single optical port communication, which is capable of performing both transmission and reception functions using only a single optical communication port and updating the firmware of an MCU via the single optical communication port, and a microcontroller which is capable of updating firmware.

Another object of the present invention is to provide a method of updating firmware using single optical port communication, which is capable of updating firmware without switching a circuit because a single optical communication port is used, thereby reducing the unit cost of an MCU, and a microcontroller which is capable of updating firmware.

In accordance with an aspect of the present invention, there is provided a method of updating firmware using single optical port communication, including: when a firmware update start code, transmitted by a transmitter, is received by a single optical port capable of both of transmitting and receiving data, detecting the voltage of a battery; if the detected voltage of the battery is equal to or higher than a predetermined reference voltage, transmitting firmware-related information to the transmitter via the single optical port; receiving update data corresponding to an update mode determined in accordance with the firmware-related information transmitted by the transmitter, and storing the received update data in a predetermined storage area; if the stored update data is update data in a first mode in which firmware can be restored, storing rollback information related to previous version of firmware, and performing an update to new version of firmware using the update data; and if the stored update data is update data in a second mode in which the predetermined data of the previous version of firmware is updated, updating the predetermined data of the previous version of firmware using the update data.

The update data may include update mode information, a total packet size, and a valid check code; and the storing may include checking the validity of the update data via the valid check code, and, if the update data is valid, storing the update data in the predetermined storage area.

The method may further include increasing an error data number when an error occurs during the checking of the validity or the update data is not valid, and, if the increased error data number is equal to or smaller than a predetermined designated error number, transmitting a packet error and a retransmission request code requesting the retransmission of update data to the transmitter.

The firmware-related information may include the version information of the previous version of firmware and the size of an empty area where data can be stored; and the update mode may be determined by the version information of the previous version of firmware and the size of the empty area.

The firmware update start code and the update data may be received as the voltages of photo-electromotive force generated in a light-emitting diode (LED) by radiated light when the transmitter radiates the light, corresponding to the firmware update start code and the update data, to the LED connected to the single optical port after the single optical port has switched to a reception mode.

The firmware update start code and the update data may be received as one of: carrier type using a time ratio between a high section and a low section input to a predetermined carrier, and flash type using a time ratio between sections between times at which light radiated by the transmitter is received by a light-emitting diode (LED) connected to the single optical port.

In accordance with another aspect of the present invention, there is provided a microcontroller (MCU) capable of updating firmware using single optical port communication, including: a battery voltage detection circuit configured to, when a firmware update start code, transmitted by a transmitter, is received by a single optical port capable of both of transmitting and receiving data, detect a voltage of a battery; an information transmission circuit configured to, if the detected voltage of the battery is equal to or higher than a predetermined reference voltage, transmit firmware-related information to the transmitter via the single optical port; a storage unit configured to receive update data corresponding to an update mode determined in accordance with the firmware-related information transmitted by the transmitter, and to store the received update data in a predetermined storage area; and a firmware update control circuit configured to, if the stored update data is update data in a first mode in which firmware can be restored, store rollback information related to previous version of firmware, and perform an update to new version of firmware using the update data, and, if the stored update data is update data in a second mode in which the predetermined data of the previous version of firmware is updated, update the predetermined data of the previous version of firmware using the update data.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are exemplary diagrams illustrating photo-electromotive force in an LED;

FIG. 2 is a diagram showing an example of the configuration of the external circuit of an MCU using a single optical communication port;

FIG. 3 is a diagram showing the configuration of a circuit using a single optical communication port in accordance with an embodiment of the present invention;

FIGS. 4A and 4B are operation flowcharts showing an operation in the data reception mode of an MCU in accordance with an embodiment of the present invention;

FIG. 5 shows an example of the digital scope waveform of a single optical communication port in a data reception mode;

FIG. 6 shows the waveform of an example of a data reception signal;

FIG. 7 shows examples of the transmission waveforms of carrier type and flash type;

FIG. 8 is an exemplary diagram illustrating the advantage of carrier type in an optical communication method;

FIGS. 9A, 9B and 9C are operation flowcharts showing a firmware update method using a single optical communication port in accordance with an embodiment of the present invention;

FIG. 10 shows an example of a firmware update mode; and

FIG. 11 shows the configuration of a microcontroller capable of updating firmware using a single optical communication port in accordance with an embodiment of the present invention.

### DETAILED DESCRIPTION OF THE DISCLOSURE

Embodiments of the present invention will be described in detail with reference to the accompanying drawings. In the following description of the present invention, detailed descriptions of related well-known components or functions that may unnecessarily make the gist of the present invention obscure will be omitted.

However, the prevent invention is not limited to the embodiments. Throughout the accompanying drawings, the same reference symbols are assigned to the same components.

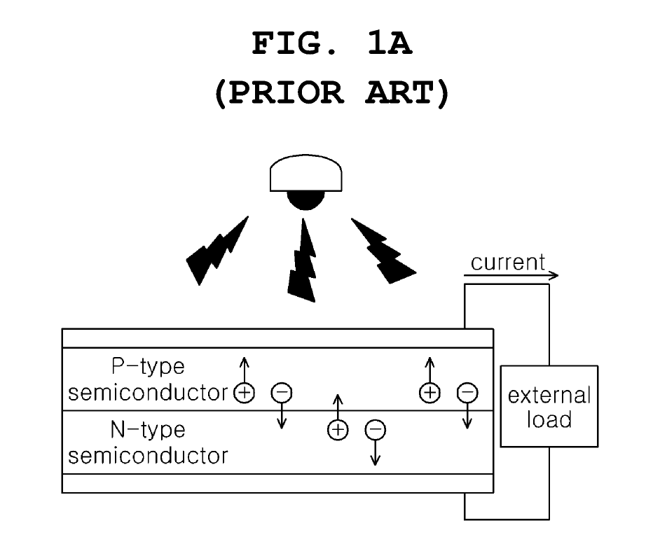

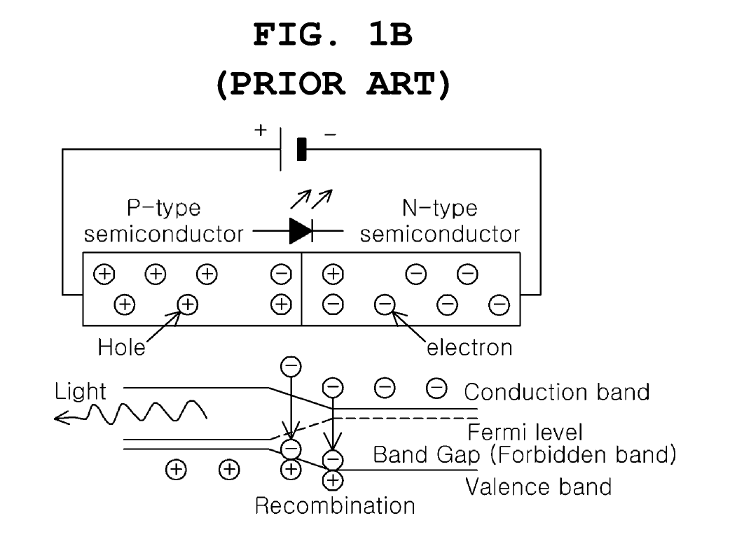

A method of updating firmware using single optical port communication and a microcontroller capable of updating firmware in accordance with embodiments of the present invention are described in detail below with reference to FIGS. 1A to 11.

A pad bonded to a port via a gold wire in an MCU is influenced by the precision of a bonding apparatus. If the size of the pad is reduced to a size equal to or smaller than a predetermined size, the rate of occurrence of defects is increased during a bonding operation, and the manufacturing cost is also increased. Accordingly, a size equal to or larger than a predetermined size is preferable for each process, and this is a factor that highly influences a chip size. Therefore, in the case of an MCU, cost competitiveness can be increased when the number of ports is small with respect the same function.

The present invention performs both the control of an external display and the updating of firmware using a single optical communication port, and does not require an additional port for the updating of firmware, so that firmware can be updated without requiring an additional circuit or switching a circuit, thereby reducing the unit cost of an MCU set.

FIGS. 1A and 1B are exemplary diagrams illustrating photo-electromotive force in an LED.

As shown in FIGS. 1A and 1B, when high-intensity light is incident on the junction part of a P-N junction semiconductor, electrons and holes generated within the semiconductor are separated due to a contact potential difference, and thus photo-electromotive force in which different types of electricity appear in both materials is generated. Commonly, inexpensive electronic apparatuses employ light-emitting diodes (LEDs) in order to notify a user or an outside of a current state. These LEDs have the PN junction structure of a semiconductor.

Accordingly, in accordance with the present invention, a transmitter that provides data required for the updating of firmware radiates light onto an LED used for the control of an external display, thereby updating the firmware of an MCU using a small amount of current or photo-electromotive force generated by the LED.

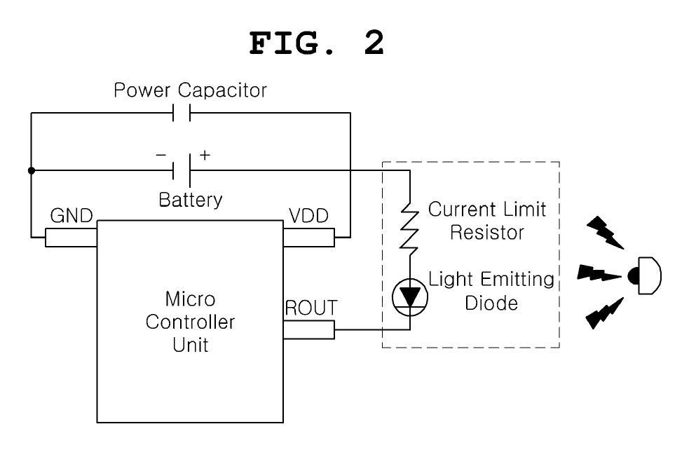

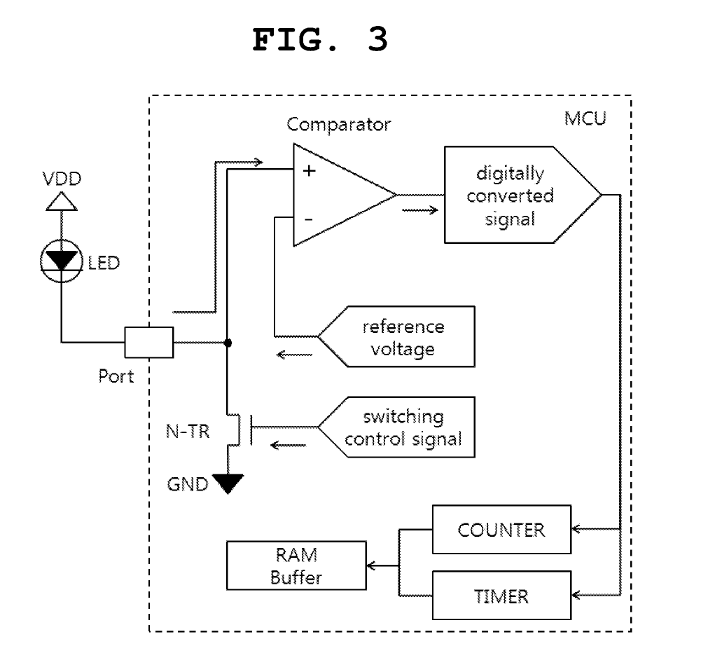

FIG. 2 is a diagram showing an example of the configuration of the external circuit of an MCU using a single optical communication port, and FIG. 3 is a diagram showing the configuration of a circuit using a single optical communication port in accordance with an embodiment of the present invention.

Referring to FIGS. 2 and 3, the external circuit of an MCU may include a battery and power capacitor configured to apply voltage VDD to the MCU, an LED configured to perform single optical port communication, and a current limit resistor disposed between the LED and a VDD port. It will be apparent that the current limit resistor may not be provided when necessary.

The data communication of the present invention uses half-duplex communication that transmits data in one direction at one time because a single optical communication port is used. N-TR shown in FIG. 3 is a transistor that is used to turn on an LED when the LED is used in a display mode or when data is transmitted.

An operation in a data reception mode is described with reference to FIG. 3 below.

In a data reception mode, a “low” switching control signal is applied to an N-TR Enable port, the N-TR enters a cut-off state, and a timer, a counter and a RAM buffer are initialized to determine a signal received via an LED.

It may be possible to measure VDD voltage applied to the MCU using an internal Voltage Detect Indicator (VDI; not shown) and set the reference voltage of a comparator optimal for the carrier frequency of a previously agreed communication waveform and current voltage.

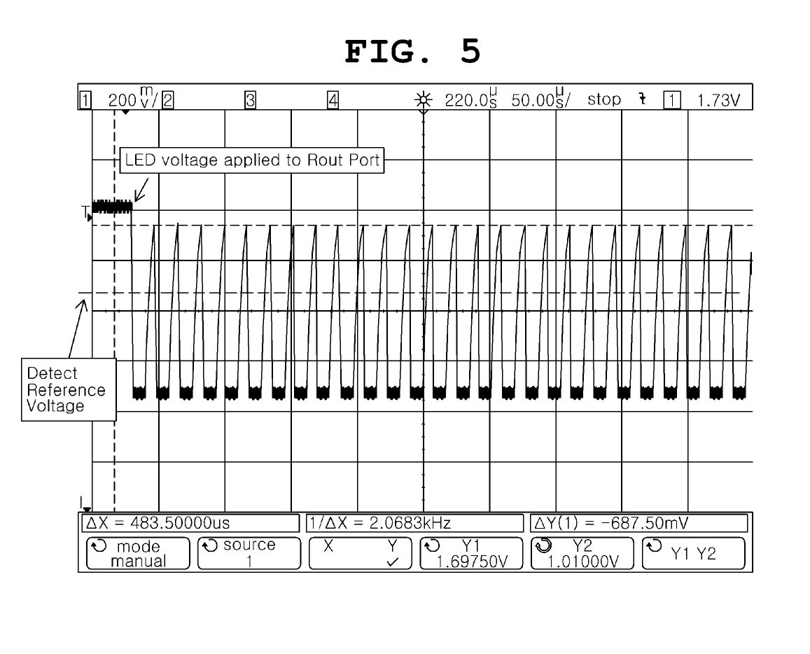

The voltage generated by photo-electromotive force is highly influenced by current VDD, carrier frequency, and the amount of light radiated onto the LED connected to the single optical communication port of the MCU. Even when a specific or larger amount of light is radiated, the photo-electromotive force generated in the LED does not increase above a specific level due to its limitation. Furthermore, when frequency is high, saturation is rapidly reached depending on the photo-electromotive force switching characteristics and impedance component of the LED. Even in the OFF section of a carrier, the characteristic in which the ON signal of the carrier is input before a rise to a reference voltage and voltage decreases is exhibited, as shown in FIG. 5. Accordingly, the carrier frequency and communication effective distance band of data communication must be appropriately set.

During a specific period after initialization, a start signal in previously agreed data format is waited for. When an optical signal is radiated from an outside, i.e., the transmitter, to the LED, a small current is generated in the LED due to a photo-electromotive force effect. The comparator compares a voltage generated by the small current of the LED with a reference voltage, and outputs a digitally converted signal in which a voltage equal to or higher than the reference voltage has been converted into digital signal “1” and a voltage lower than the reference voltage has been converted into digital signal “0.”

The converted digital signal is sampled by the timer and the counter and stored in the RAM buffer, and it is determined based on previously agreed waveform information format whether the stored data is effective data. When valid input has not been input during this time, i.e., during a data reception mode, an operation is performed in a data transmission mode or an operation is performed as that of a general LED.

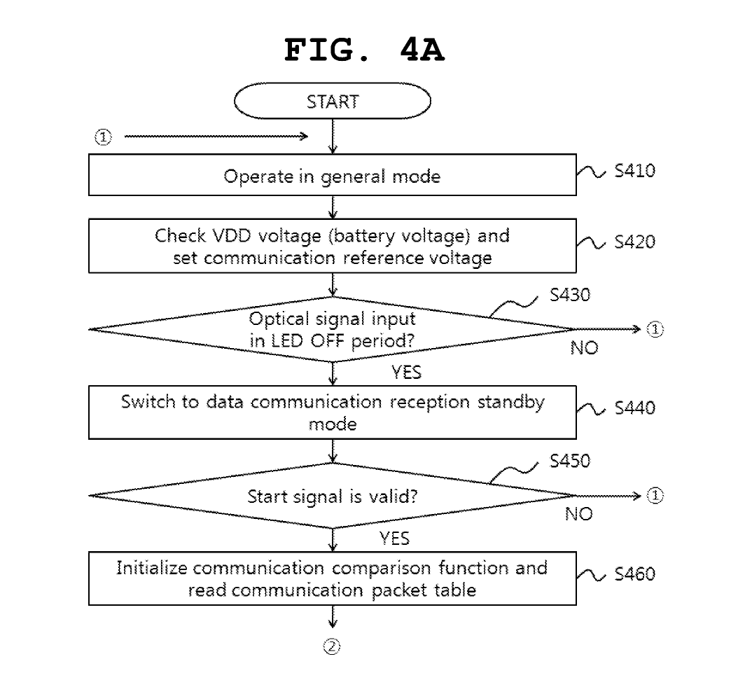

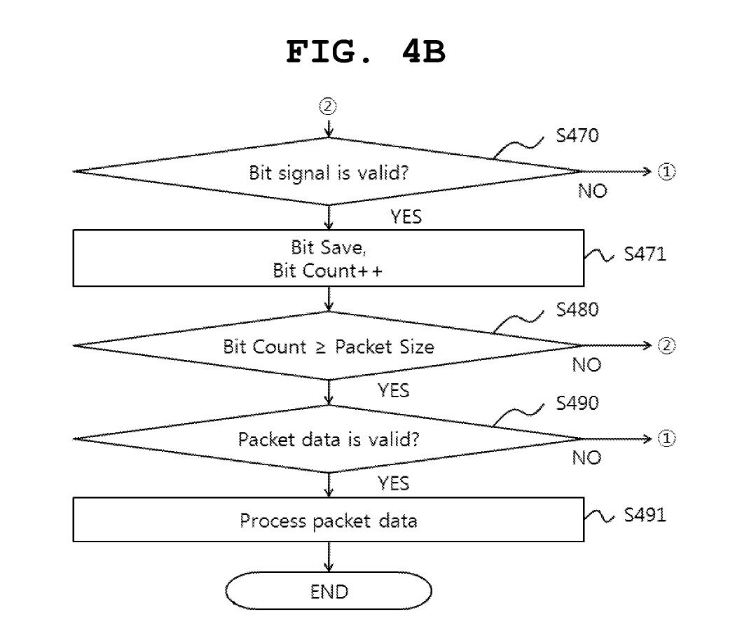

An operation in a data reception mode is described in greater detail with reference to FIGS. 4A and 4B.

FIGS. 4A and 4B are operation flowcharts showing the data reception mode of an MCU in accordance with an embodiment of the present invention. As shown in FIGS. 4A and 4B, in operation 5410 and 5420, the data reception mode sets a reference voltage, i.e., one of the two input voltages of the comparator that checks battery voltage VDD during general mode operation and converts received data into 1 and 0.

In operation 5430, it is determined whether an optical signal has been input from the transmitter to the LED during an OFF period of the LED, in operation 5440, a mode is switched to a data communication reception standby mode when an optical signal is input, and it is determined whether a start signal is valid based on the received optical signal in operation 5450.

If it is determined that the start signal is valid in operation 5450, a communication comparison function is initialized and a communication packet table is read in operation 5460, thereby determining whether a bit signal is valid in operation 5470. If the bit signal is valid, the valid bit is stored, and the validity of its subsequent bit signal is determined in operation 5471.

The process of performing the determination of the validity of a bit signal and storage is repeated a number of times corresponding to a packet size in operations 5470, 5471 and S480. After this process has been completed, it is determined whether a packet data is valid in operation S490, and the packet data is processed in operation S491 if the packet data is valid, thereby performing the process of the data reception mode.

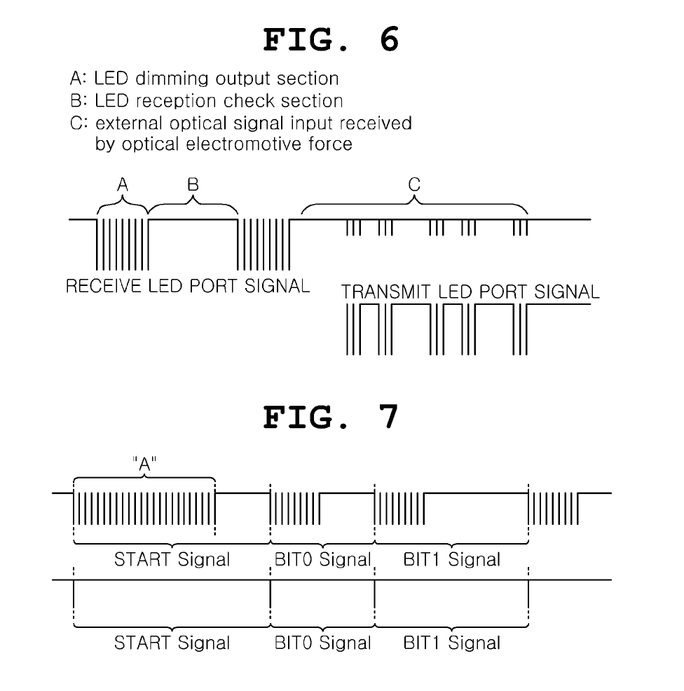

FIG. 6 shows the waveform of an example of a data reception signal. This drawing shows input to the optical communication port, connected to the LED, during the reception of data.

As shown in FIG. 6, the LED connected to the single optical communication port operates in an output mode or transmission mode (see section A), and then operates in a reception mode in which the LED stops output and checks whether there is a received signal, as in sections B and C. If there is no input signal in sections B and C, the LED operates to perform output again, and determines an entering signal when a valid input enters.

Section C illustrates that an LED port signal transmitted by the transmitter is radiated onto the LED and the signal is transcribed by photo-electromotive force. In the present invention, the format and structure of communication data can vary depending on the apparatus and purpose used. The format of communication data may include a carrier frequency, a start bit, BIT0, BIT1, and delay hold time. The structure of data may include a start code, a packet ID, a control code, an index address, and a checksum, as shown in Table 1 below:

TABLE 1

| | | | | |
|---|---|---|---|---|
| Start | Packet ID | Control | Index | Checksum |
| Code | | Code | Address | |

In this case, the start code is a signal adapted to identify the start of communication data, the packet ID refers to an ID address adapted to perform matching between a master, such as a transmitter, and a slave, such as a receiver, the index address refers to a target index address adapted such that the control code will be applied thereto, and the checksum refers to a code value adapted to check whether the packet data is valid.

The start code and the individual data bits may be divided into a carrier frequency, a bit high section, and a bit low section. The types of transmission format may be divided into the type with carrier frequency, such as carrier type, and he type without carrier frequency, such as flash type.

In the case of the carrier type, when the transmitter transmits data, the transmitter transmits a waveform in which a specific carrier frequency has been combined (for example, AND-combined) with a signal to be transmitted to the receiver, and distinguishes the start signal of data and a BIT0 signal and a BIT1 signal, i.e., the binary data of data to be transmitted, based on the time ratio between a high section and a low section input to a designated or set carrier, as in the upper one of the waveforms shown in FIG. 7. For example, in the case of the start signal, the time of high section A is longer than that of the low section, in the case of Bit0, the time of the high section is the same as that of the low section, and in the case of Bit1, the high section is shorter than that of the low section.

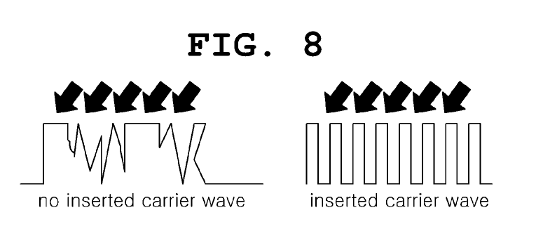

With regard to the characteristics of the carrier type, in the case of a transmission signal including no carrier (a no carrier inserted wave), the signal may be lost or distorted due to optical noise, whereas in the case of a transmission signal including a carrier (a carrier inserted wave), the signal has a characteristic robust to the loss and distortion of the signal and noise attributable to optical noise, as shown in FIG. 8.

When data is transmitted using the carrier type, it is preferable to design the configuration of data format while considering switching speed based on photo-electromotive force input. As shown in FIG. 5, it can be seen that a carrier OFF section received by the single optical port rises with a slope, a subsequent signal is applied before carrier OFF section rises to an initial state voltage level without input, and thus there is a difference between a maximum voltage level and an initial voltage level in an input section. The corresponding section in which there is a difference between a maximum voltage level and an initial voltage level increases in proportion to the amount of light of the transmitter and the input frequency. The reason for this is that the time it takes for the voltage generated by the current generated by photo-electromotive force to be discharged is required depending on the LED. Accordingly, when the discharge time is slower than the carrier speed, a saturation section occurs, and thus a section in which a signal is distorted occurs depending on the location of a reference voltage adapted to determine a signal.

It will be apparent that using the above-described characteristic, an implementation can be made such that a signal can be transmitted and received only in a specific distance section depending on the amount of light and frequency of the transmitter.

The flash type distinguishes the start signal of data and a BIT0 signal and a BIT1 signal, i.e., the binary data of data to be transmitted, based on the time ratio between a short section and a section from the time at which a light source, for example, the LED, is turned on to the time at which the light source is turned on next, during data transmission.

Although the flash type has a poorer noise immunity characteristic than the carrier type, it can easily ensure discharge time compared to the carrier type because it does not use a carrier, and thus can implement faster communication speed than the carrier type in overall.

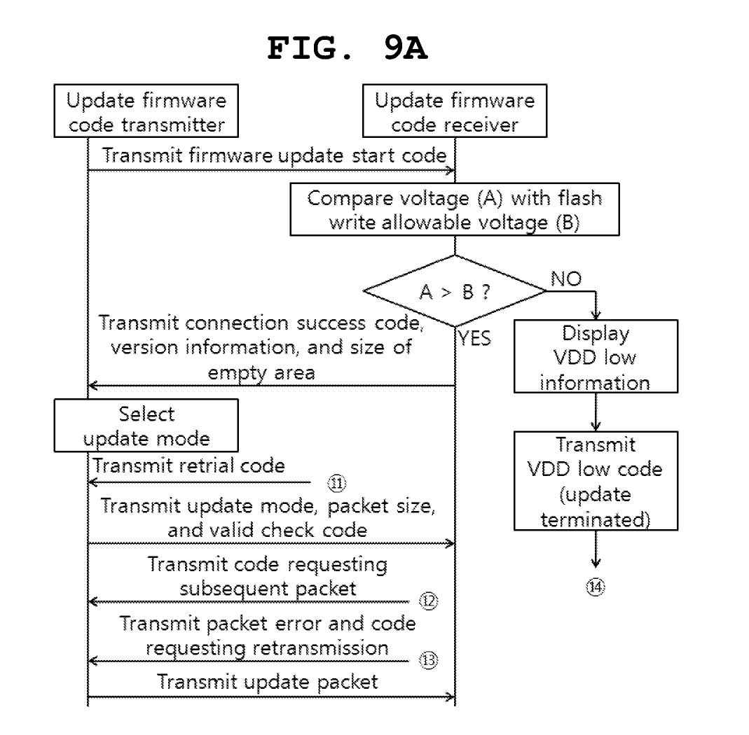

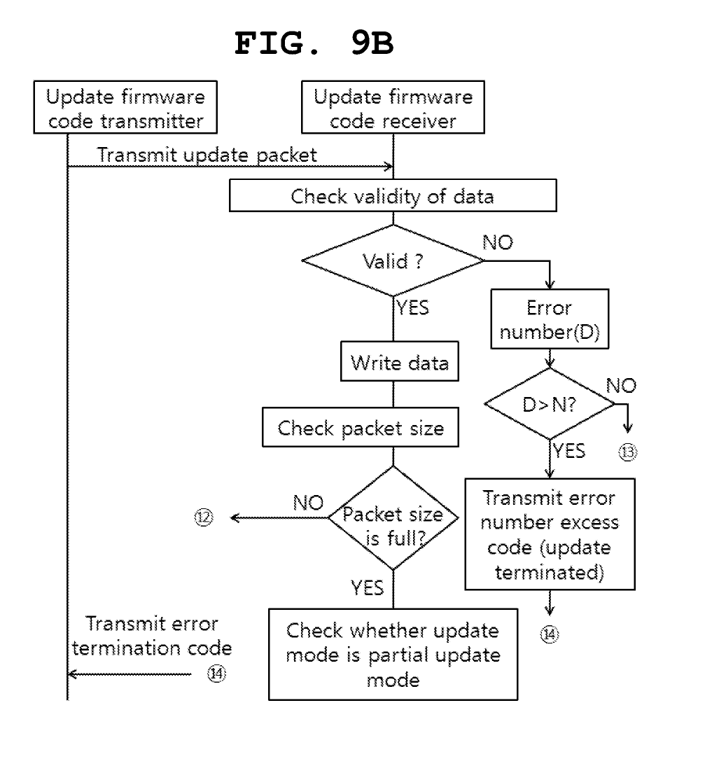

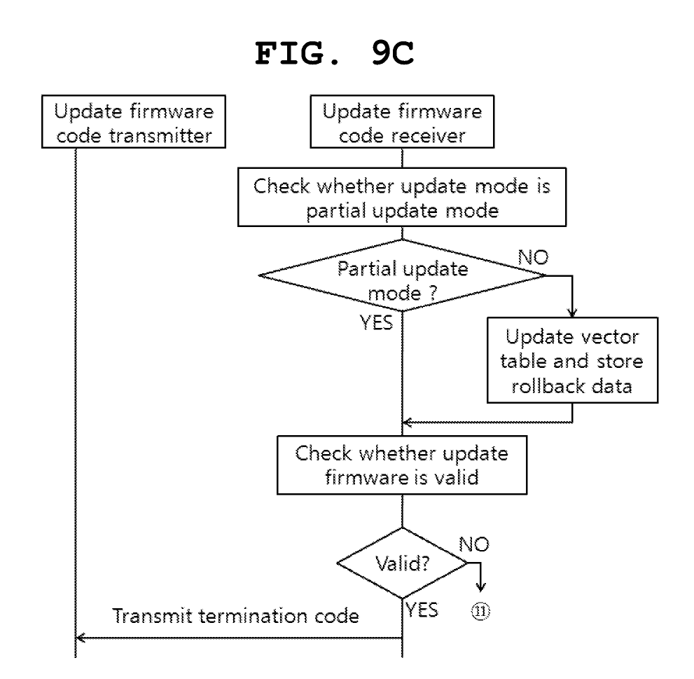

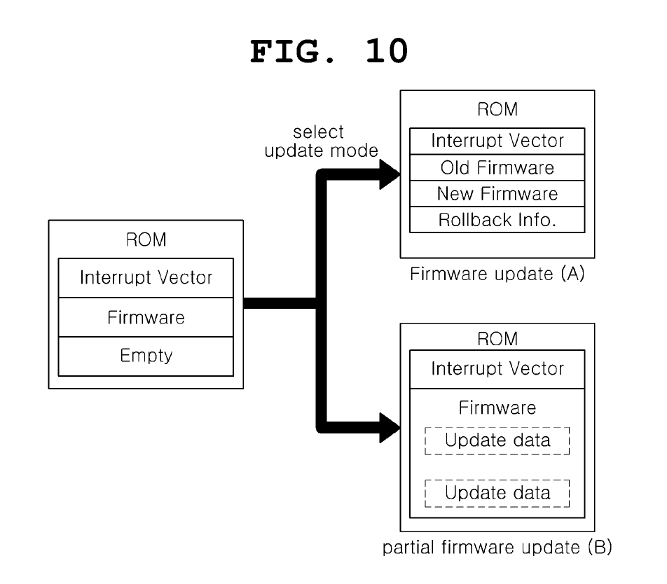

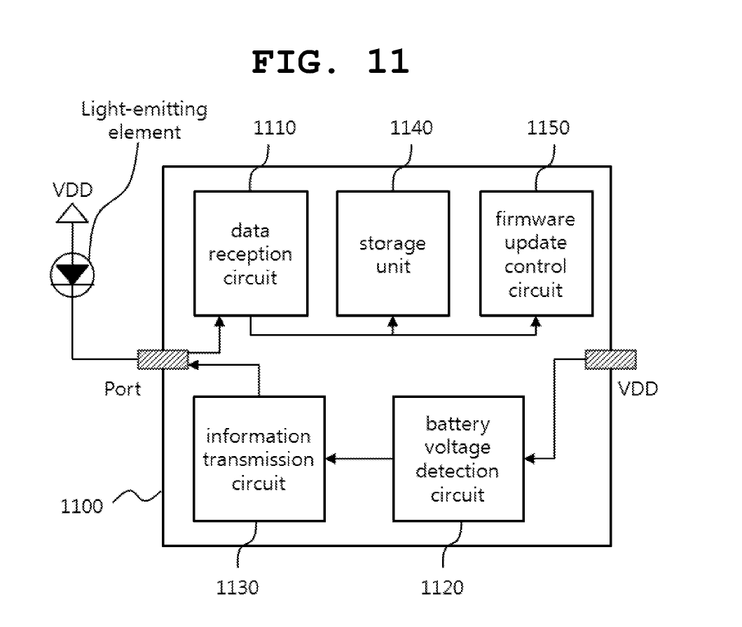

FIGS. 9A, 9B, 9C are operation flowcharts showing a firmware update method using a single optical communication port in accordance with an embodiment of the present invention, and FIG. 10 shows an example of a firmware update mode.

Referring to FIGS. 9A through 9C and 10, in the firmware update method in accordance with the present embodiment, when the MCU adapted to perform firmware update of a receiver (an update firmware code receiver) receives a firmware update start code transmitted by the radiation of the light of a transmitter (an update firmware code transmitter), it is determined whether a measured VDD voltage is equal to higher than an allowable voltage by measuring a current VDD voltage (a battery voltage) using an internal VDI (Voltage Detect Indicator) and then comparing the measured VDD voltage A with allowable voltage B predetermined to determine whether to perform firmware update.

If the battery voltage of the MCU is within an update allowable voltage range, a connection success code, firmware version information, i.e., the current firmware version information of the MCU, and the size of an empty area where data can be stored are transmitted to the transmitter. In contrast, if the battery voltage is out of the allowable voltage range, an allowable voltage error code is transmitted to the transmitter, and then the update mode is terminated.

When receiving the connection success code, the current firmware version information of the MCU and the size of the empty area transmitted by the receiver, the transmitter determines an update mode while considering the size of the empty area and the version information.

In the present invention, the firmware update mode may include two different modes, as shown in FIG. 10. The two update modes may include a restorable firmware update mode A in which the firmware of a receiver MCU before update can be restored, and a partial firmware update mode B in which the partial data of the current firmware of a receiver MCU can be updated.

When an update is performed in the restorable update mode, the ROM area of an MCU includes new version of firmware, old firmware, and rollback information data.

In the restorable firmware update mode, when the empty area of the ROM of a receiver MCU is equal to or larger than a new version of firmware update code and rollback information, the new version of firmware code is stored in the empty area, and an interrupt vector is corrected into the function address of a new version of firmware code.

The restorable firmware update mode has the advantage of being able to restore new version of firmware having a problem because previous version of firmware is preserved.

Although a partial firmware update mode provides fast firmware update speed because only changed data is replaced with corresponding part of previous version of firmware or only part of previous version of firmware is updated, it has the disadvantage of being unable to perform restoration if previous version of firmware is not received because firmware data is changed.

As described above, when the transmitter determines an update mode, update mode information, a total packet size, and a valid check code are transmitted to the receiver.

When the receiver receives update firmware data, i.e., firmware update data, from the transmitter, the receiver checks the validity of data and stores the data in a RAM buffer.

In this case, when a flash block write size is reached, the MCU checks the validity of data again, and stores the data if it is valid.

When an error occurs in the above process, an error data number is increased. If the error data number is equal to or smaller than a predetermined designated error number or a reference error number, a packet error and retransmission request code is transmitted to the transmitter. If the error data number exceeds the designated error number, an error transmission termination code is transmitted to the transmitter, and the firmware update mode is terminated.

In contrast, if the received data is valid, the receiver transmits a code requesting a subsequent packet to the transmitter until packets corresponding to a packet size are received.

Once all packets corresponding to the packet size have been received, whether the received update data corresponds to a partial firmware update mode or restorable firmware update mode is determined. If the received update data corresponds to a partial firmware update mode, the validity of the update data is checked. If the update data is valid, the partial update of the firmware is performed, an update termination code is transmitted to the transmitter, and the update is terminated.

In contrast, if the update mode is a restorable update mode, a vector table is updated, rollback information related to previous version of firmware is stored, and then the validity of the update data is checked. If the update data is valid, the partial update of the firmware is performed, an update termination code is transmitted to the transmitter, and the update is terminated.

Once all update data packets required for firmware update are transmitted to the receiver, the transmitter stores rollback information related to previous version of firmware with respect to the restorable firmware update mode, updates an interrupt vector table in accordance with new version of firmware, and resets a program start address.

FIG. 11 shows the configuration of a microcontroller capable of updating firmware using a single optical communication port in accordance with an embodiment of the present invention, and may perform all operations required to update the above-described firmware.

Referring to FIG. 11, a microcontroller MCU 1100 in accordance with the present invention includes a data receiver circuit 1110, a battery voltage detection circuit 1120, an information transmission circuit 1130, a storage unit 1140, and a firmware update control circuit 1150.

When the transmitter radiates light, corresponding to a firmware update start code and update data required for the updating of firmware, onto the LED connected to the single optical port after the MCU has switched to a data reception mode, i.e., the single optical port connected to the LED has switched to a reception mode, the data receiver circuit 1110 receives the firmware update start code and the update data as the voltages of electromotive force generated in the LED by the radiated light.

In this case, the data receiver circuit 1110 may receive data from the transmitter the above-described carrier type or flash type.

The data receiver circuit 1110 can receive not only the above-described data but also all of data required for the operation of the present invention.

The battery voltage detection circuit 1120 detects the battery voltage of the MCU when the firmware update start code transmitted from the transmitter is received by the single optical port that has a data transmission function.

In this case, the battery voltage may be measured using a voltage detect indicator (VDI).

If the voltage of the battery detected by the battery voltage detection circuit 1120 is equal to or higher than a predetermined reference voltage, the information transmission circuit 1130 transmits firmware-related information to the transmitter via the single optical port.

In this case, the firmware-related information may include a connection success code, firmware version information, and the size of an empty area where data can be stored.

The storage unit 1140 receives update data corresponding to the update mode determined by the transmitter via the data receiver circuit 1110, and stores the received update data in a predetermined storage area.

In this case, the update mode may be determined by the transmitter using firmware-related information transmitted from the information transmission circuit 1130 to the transmitter via the single optical port. This update mode may be determined by considering firmware version information and the size of an empty area where data can be stored.

The update data stored in the storage unit 1140 may include update mode information, a total packet size, and a valid check code.

If the update mode determined by the transmitter is a restorable firmware update mode in which previous version of firmware can be restored, the firmware update control circuit 1150 stores rollback information related to previous version of firmware, an update to new version of firmware is performed using update data received from the transmitter. In contrast, if the update mode determined by the transmitter is a partial firmware update mode, partial data, i.e., predetermined data, of the firmware of the MCU is replaced or updated using update data received from the transmitter.

In this case, the firmware update control circuit 1150 checks the validity of the update data via a valid check code, and may store the update data in a predetermined storage area of the storage unit if the update data is valid.

In this case, the firmware update control circuit 1150 increases an error data number when an error occurs during the checking of validity or the update data is not valid, and, if the increased error data number is equal to or smaller than a predetermined designated error number, may transmit a packet error and a retransmission request code requesting the retransmission of update data to the transmitter by controlling the information transmission circuit 1130.

The MCU capable of updating firmware in accordance with the present invention may include not only the above-described updating function but also all the functions described with reference to FIGS. 1A to 10.

In accordance with the present invention, both transmission and reception functions can be performed using a single optical communication port, and the firmware of an MCU can be updated using the single optical communication port, thereby updating firmware without changing a circuit and also reducing the unit cost of a set.

The conventional Infrared Data Association (IrDA) communication and Visible Light Communication (VLC) using LEDs require a transmission port and a reception port used for reception and transmission and also requires the circuit configurations of additional circuits and sensors required for the corresponding implementations. In contrast, the present invention uses a single optical communication port. Accordingly, this embodiment of the present invention uses a minimized circuit and a minimum number of port, thereby ensuring the cost competitiveness of an MCU thanks to the minimized circuit and the minimum number of port, and uses the LED of an external display to perform communication in order to update firmware, thereby minimizing the configuration of an additional mechanism or influence on an appearance and thus improving the utilization of space and the efficiency of design.

Furthermore, the present invention updates firmware using a single optical communication port, and thus it is not necessary to disassemble and assemble an inexpensive mechanism using no additional fastener parts, such as a nut and a screw, in order to update firmware, thereby preventing damage to a product, which may occur during disassembly/assembly.

While the present invention has been described in conjunction with specific details, such as specific elements, and limited embodiments and diagrams above, these are provided merely to help an overall understanding of the present invention. The present invention is not limited to these embodiments, and various modifications and variations can be made based on the foregoing description by those having ordinary knowledge in the art to which the present invention pertains.

Accordingly, the technical spirit of the present invention should not be determined based on only the described embodiments, and the following claims, all equivalents to the claims and equivalent modifications should be construed as falling within the scope of the spirit of the present invention.

What is claimed is:

1. A method of updating firmware using single optical port communication, comprising:
detecting a voltage of a battery when a firmware update start code, transmitted by a transmitter, is received by a single optical port capable of both of transmitting and receiving data;
transmitting firmware-related information to the transmitter via the single optical port if the detected voltage of the battery is equal to or higher than a predetermined reference voltage;
receiving update data corresponding to an update mode determined in accordance with the firmware-related information transmitted by the transmitter;
storing the received update data in a predetermined storage area of a storage device;
if the stored update data is update data in a first mode in which firmware can be restored, storing rollback information related to previous version of firmware, and performing an update to new version of firmware using the update data; and
if the stored update data is update data in a second mode in which predetermined data of the previous version of firmware is updated, updating the predetermined data of the previous version of firmware using the update data.

2. The method of claim 1, wherein:
the update data comprises update mode information, a total packet size, and a valid check code; and
the storing comprises:
checking validity of the update data via the valid check code; and
if the update data is valid, storing the update data in the predetermined storage area.

3. The method of claim 2, further comprising increasing an error data number when an error occurs during the checking of the validity or the update data is not valid, and, if the increased error data number is equal to or smaller than a predetermined designated error number, transmitting a packet error and a retransmission request code requesting retransmission of update data to the transmitter.

4. The method of claim 1, wherein:
the firmware-related information comprises version information of the previous version of firmware and a size of an empty area where data can be stored; and
the update mode is determined by the version information of the previous version of firmware and the size of the empty area.

5. The method of claim 1, wherein the firmware update start code and the update data are received as voltages of photo-electromotive force generated in a light-emitting diode (LED) by radiated light when the transmitter radiates the light, corresponding to the firmware update start code and the update data, to the LED connected to the single optical port after the single optical port has switched to a reception mode.

6. The method of claim 1, wherein the firmware update start code and the update data are received as one of: carrier type using a time ratio between a high section and a low section input to a predetermined carrier, and flash type using a time ratio between sections between times at which light radiated by the transmitter is received by a light-emitting diode (LED) connected to the single optical port.

7. A microcontroller (MCU) capable of updating firmware using single optical port communication, comprising:
a battery voltage detection circuit configured to detect a voltage of a battery when a firmware update start code, transmitted by a transmitter, is received via a single optical port capable of both of transmitting and receiving data;
an information transmission circuit configured to transmit firmware-related information to the transmitter via the single optical port if the detected voltage of the battery is equal to or higher than a predetermined reference voltage;
a storage unit configured to:
receive update data corresponding to an update mode determined in accordance with the firmware-related information transmitted by the transmitter; and
store the received update data in a predetermined storage area; and
a firmware update control circuit configured to:
if the stored update data is update data in a first mode in which firmware can be restored, store rollback information related to previous version of firmware, and perform an update to new version of firmware using the update data; and
if the stored update data is update data in a second mode in which predetermined data of the previous version of firmware is updated, update the predetermined data of the previous version of firmware using the update data.

8. The MCU of claim 7, wherein:
the update data comprises update mode information, a total packet size, and a valid check code; and
the firmware update control circuit is further configured to:
check validity of the update data via the valid check code; and
if the update data is valid, store the update data in the predetermined storage area.

9. The MCU of claim 8, wherein the firmware update control circuit is further configured to:
increase an error data number when an error occurs during the checking of the validity or the update data is not valid; and
if the increased error data number is equal to or smaller than a predetermined designated error number, transmit a packet error and a retransmission request code requesting retransmission of update data to the transmitter.

10. The MCU of claim 7, wherein:
the firmware-related information comprises version information of the previous version of firmware and a size of an empty area where data can be stored; and
the update mode is determined by the version information of the previous version of firmware and the size of the empty area.

11. The MCU of claim 7, further comprising a data receiver circuit configured to receive the firmware update start code and the update data as voltages of photo-electromotive force generated in a light-emitting diode (LED) by radiated light when the transmitter radiates the light, corresponding to the firmware update start code and the update data, to the LED connected to the single optical port after the single optical port has switched to a reception mode.

12. The MCU of claim 7, further comprising a data receiver circuit configured to receive the firmware update start code and the update data as one of: carrier type using a time ratio between a high section and a low section input to a predetermined carrier, and flash type using a time ratio between sections between times at which light radiated by the transmitter is received by a light-emitting diode (LED) connected to the single optical port.
